(19) United States
(12) Patent Application Publication
(10) Pub. No.: US 2025/0128167 A1
(43) Pub. Date: Apr. 24, 2025

(54) SYSTEMS AND METHODS FOR GENERATIVE GAME WORLD POPULATION AND GAME ELEMENT TAGS

(71) Applicant: Sony Interactive Entertainment Inc., Tokyo (JP)

(72) Inventors: Charles McCoy, San Diego, CA (US); True Xiong, San Diego, CA (US)

(73) Assignee: Sony Interactive Entertainment Inc., Tokyo (JP)

(21) Appl. No.: 18/492,197

(22) Filed: Oct. 23, 2023

(51) Int. Cl. A63F 13/65; A63F 13/67; A63F 13/69

(52) U.S. Cl. CPC A63F 13/65; A63F 13/67; A63F 13/69; A63F 2300/55

(57) ABSTRACT

System, process, and device configurations are provided for generative game world population. A method can include determining elements for populating an electronic game area including generating content for a new game area of the electronic game or a new storyline component. Populating electronic game areas may include use of a game world generation model trained to generate a new game area based on a game area standard. Game world population may include new game areas and output of the game areas to appear as part of an electronic game. Game world population may be performed to generate and insert new game areas and storylines into an electronic game including a game level, game map, game storyline, design style for objects, and design of game elements. Game world generation may be based on detection of game element tags including a description of game elements.

### CROSS-REFERENCE TO RELATED APPLICATION

This application is concurrently filed with U.S. patent application Ser. No. ------ titled SYSTEMS AND METHODS FOR GENERATIVE GAME WORLD GENERATION AND PLAYER CUSTOMIZATION, and U.S. patent application Ser. No. ------ titled SYSTEMS AND METHODS FOR GENERATIVE GAME WORLD GENERATION AND USER PREFERENCE INTERFACE, the specifications of which are hereby expressly incorporated by reference in their entirety.

### FIELD

The present disclosure is directed to interactive entertainment and electronic video gaming, including gaming device operations, processes, configurations, user interface control and control device configurations, and generative processes for the population of game worlds.

### BACKGROUND

Computer and console games titles have been developed in many styles for different gaming systems and platforms. Games and content are often developed for display in a two-dimensional format that include presentation of games in a variety of formats.

As game systems and networking features evolve to include increased processing power and display quality, gaming content also improves with development of rich features and graphics. There is a desire to provide customization and tailoring to users for gaming content. Conventional development processes may limit the ability of developers to provide game content suitable to all users. In addition, many games are developed with a fixed mapping and game architecture. Some existing games allow for users to manually select features, such as a character or level. These existing games may be limited in the ability to generate game elements. Accordingly, there is a need and a desire for game systems and devices to provide user ability to control gaming content. There is also need and a desire for gaming systems to improve controllability of device operation including improving device interface control and game world population.

### BRIEF SUMMARY OF THE EMBODIMENTS

Disclosed and described herein are systems, methods and configurations for generative game world population. In one embodiment, a method detecting, by a device, a game world generation input command for an electronic game area. The method includes determining, by the device, at least one element for populating the electronic game area based on the world generation input command, wherein the determining the at least one element is based on a game world standard. The method includes outputting, by the device, game data for the electronic game area with the at least one element.

In one embodiment, the game world generation input command is at least one of a game engine command, game design command, game server command and game player command to populate at least one element of a game session.

In one embodiment, the game world standard defines at least one parameter for generating at least one of a game level, game map, game storyline, design style for objects, and game elements.

In one embodiment, the game world generation input command includes detection of a game element tag in the electronic game area, the game element tag including a description of a game element for configuration.

In one embodiment, determining the at least one element for populating the electronic game area includes generating at least one of content for a new game area of the electronic game and a new storyline component of the electronic game.

In one embodiment, determining the at least one element for populating the electronic game area includes generating at least one game element and a game area based on a storyline of the electronic game and a design theme of the electronic game.

In one embodiment, determining the at least one element for populating the electronic game area includes generating at least one game object and at least one display characteristic to populate the electronic game area, and wherein determining the at least one element includes generating elements for a template of the game area.

In one embodiment, determining the at least one element for populating the electronic game area includes generating a new game area for the electronic game using a game world generation model trained to generate the new game area based on a game area standard to include new game content.

In one embodiment, determining the at least one element for populating the electronic game area includes generating display elements for the at least one element in a newly generated game area, wherein the device uses a template generated for the electronic game to determine display attributes and game function of the at least one element.

In one embodiment, outputting game data for the electronic game includes display of the at least one element during a game session.

Another embodiment is directed to a device configured for generative game world population. The device includes an interface and memory storing executable instructions and a controller, coupled to the interface and memory. The controller is configured to detect a game world generation input command for an electronic game area. The controller is also configured to determine at least one element for populating the electronic game area based on the world generation input command, wherein the determining the at least one element is based on a game world standard. The controller is also configured to output game data for the electronic game area with the at least one element object.

Other aspects, features, and techniques will be apparent to one skilled in the relevant art in view of the following detailed description of the embodiments.

### BRIEF DESCRIPTION OF THE DRAWINGS

The features, objects, and advantages of the present disclosure will become more apparent from the detailed description set forth below when taken in conjunction with the drawings in which like reference characters identify correspondingly throughout and wherein:

FIG. 1 is a graphical representation of generative game world population according to one or more embodiments;

FIG. 2 illustrates a process for generative game world population according to one or more embodiments;

FIG. 3 illustrates a graphical representation of a system and device for game world generation according to one or more embodiments;

FIG. 4 illustrates a graphical representation of game world generation according to one or more embodiments;

FIG. 5 illustrates a graphical representation of game world training according to one or more embodiments;

FIG. 6 illustrates a graphical representation of customizing game world generation for players according to one or more embodiments;

FIG. 7 illustrates a process for customizing game world generation for players according to one or more embodiments; and

FIG. 8 illustrates a graphical representation of generating game world content for players according to one or more embodiments.

### DETAILED DESCRIPTION OF THE EXEMPLARY EMBODIMENTS

### Overview and Terminology

One aspect of the disclosure is directed to generative game world population. Embodiments are directed to gaming systems which may include consoles, processors or servers that generate game media. Processes, system configurations and device configurations according to embodiments are provided to populate game areas, such as a game area of an existing game, and to generate new areas for existing games and/or games under design. Population of a game world may include generation of game elements as part of game design, part of a game engine, game server operation and based on game player input. Game world population may apply to configuring elements and/or generating elements. Elements of a game include player controlled objects (e.g., characters), non-player controlled elements (e.g., non-player characters, opponents, borders, paths, tracks, etc.), visual elements (background, levels, maps, etc.), game storyline, game structure (e.g., game maps, levels, arrangement), audio output features, themes for display, game locations (e.g., landscape, outer space, space ship, race track, etc.) and game elements in general. According to embodiments, generative game world population includes using one or more machine learning models (ML). ML models used herein may be generated and used to for generative population of game worlds, including artificial intelligence (AI) models configured to populate game worlds and game elements. Operations and processes described herein for generative game world population may provide generative AI open world population using generative AI for the population of game worlds.

Embodiments described herein include processes, device configurations and systems for generating game worlds and for populating one or more areas of the game. According to embodiments, configurations are provided for devices to detect game elements, such as tagged elements in an electronic game that can be configured by the device. Embodiments may also be configured to detect and generate a game world structure and/or storyline. By way of example, an electronic game may include a structure having one or more game areas (e.g., levels, worlds, race tracks, landing displays, menus, interactive controls, etc.). Game areas may have one or more sub-areas, within a game area. According to embodiments, generative open world population can include configuration of game world areas, game world sub-areas and/or game world elements. Generative open world population may include generating, such as creating, a new game area and/or game sub-area for the electronic game. The game world areas may have a structure and/or relationship. For example, a first level, level 1, is played prior to a second level, level 2. Similarly, a planet or landscape is played first and then a player may access a second planet or second level. Game world areas may have a structural relationship to each other by way of layers, map locations and an arrangement relative to one another. Operations for generating game areas may be performed for generation of one or more game worlds for an electronic game. By generating a game area and/or game world, players of the electronic game may interact with video and gaming content that may be generated based on the player or group of players and to allow a new game environment generated after game design. By way of example, game designers may generate a game including multiple levels or games areas. Embodiments include processes to add one or more additional levels to the game.

According to embodiments processes, device configurations and systems for generating of game worlds and for populating one or more areas of the game may including generating one or more storylines elements for an electronic game. An electronic game may include one or more characters and one or more storyline elements. For example, the storyline may require a character to accumulate or locate items before challenging a game boss. Alternatively, the storyline may include details of characters, including player controlled and non-player characters. Embodiments can modify a storyline to include populating one or more details of the storyline. According to embodiments, embodiments can include generating a storyline and inserting the storyline in the electronic game. Storyline generation according to embodiments can include recognizing character actions or endings (e.g., defeated character, demolished game object etc.).

According to embodiments, processes and device configurations may include detecting one or more game tags or tagged elements for populating a game world. Electronic games may include one or more game elements that may be tagged, or marked, such that a device can detect the element and populate the element. Populating an element may include one or more of setting a display characteristic, setting appearance of the element, modifying the theme of an element, selecting output configurations for the element (e.g., game effects, voice or text output of the element, and interaction of the element in the game). Processes and device configurations may include detecting one or more game templates for populating a game world. A game template may include one or more of a game structure and game storyline.

According to embodiments, processes are provided for generating game worlds and populating game worlds based on one or more of player interest and player actions within a game, such as in-game controls. By using player actions and player preferences, an electronic game may be presented based on player actions in the game. As such, player actions can be detected and used to effect one or more of game structure and game storyline. In addition, player interactions and input commands of multiple players may be detected and used to generate one or more of a game area and game storyline.

Embodiments are also directed to systems, devices and methods for generating a model and training a device using the model for population of a game world. Operations may be performed during training to identify characteristics of a game and/or players interactions with game such that population of the game world includes one or more of a consistent design, them or logic. The model may be generated to populate an existing game area.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation.

### EXEMPLARY EMBODIMENTS

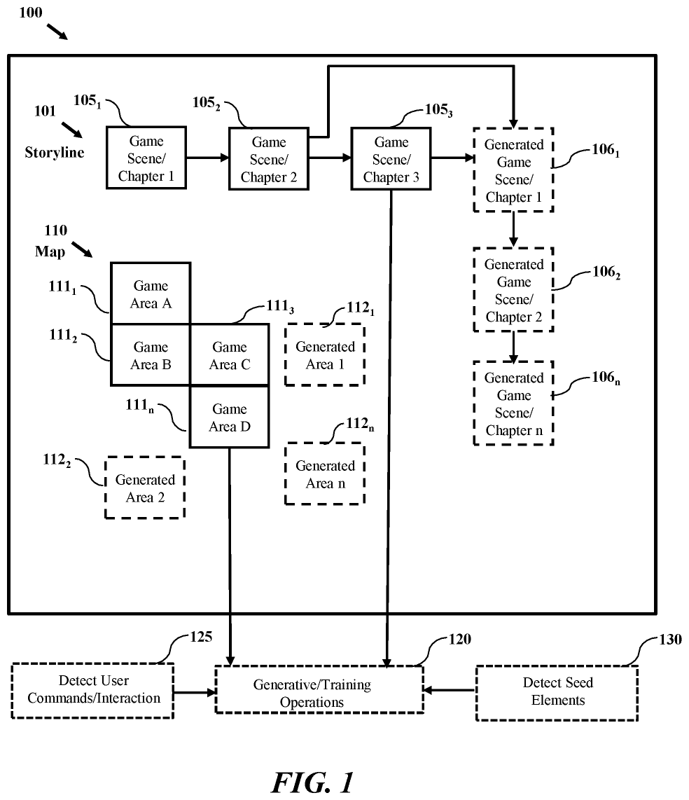

FIG. 1 is a graphical representation of generative game world population according to one or more embodiments. FIG. 1 illustrates an electronic game 100 including a game storyline 101 including a plurality of scenes 1051-n and game structure 110 including a plurality of game areas 1111-n. According to embodiments, processes and device configurations are configured for generative game world population of an electronic game, such as electronic game 100 to add and/or modify one or more game elements. Generative game world population of electronic game 100 can include adding and/or modifying game storyline 101, such as one or more of scenes 1051-n. Generative game world population can include determining one or more storyline elements, such as scenes 1061-n. When generated, scenes 1061-n may be added to storyline 101, and the arrangement and order of scenes 1061-n may be added in addition to and/or in between one or more of game scenes 1051-n. According to embodiments, generative game world population of electronic game 100 can include adding and/or modifying elements to game areas, such as game areas 1111-n. Generative game world population can include determining one or game areas (new game areas), such as game areas 1121-n. When generated, game areas 1121-n may be added to game structure 110, and the arrangement and order of game areas 1121-n may be added in addition to and/or in between one or more of game areas 1111-n.

According to embodiments, generative game world population may include adding a game area or game element by linking to one or more elements of a game. In some cases, a new game area may build on content that already exists in the game. For example, a new side character may be added to an existing game map may be extended, and a back-story or other enrichment may be added to an existing story. The backstory or enrichment can provide a character arc for an existing character, or add a sub-plot that branches off of the existing game story. In some cases, a new game area may stand alone from existing game content, such as to be a sub-game, side-quest, or stand-alone adventure. In the cases where a new game area is added there are many different ways that the new game area can be linked to the existing game world, some of which will be more appropriate for certain game titles. For example, in a space game a player might be able to travel to a planet by entering its coordinates into a ship's navigation system, which will allow a new planet to be added just by providing the coordinates for the new planet to the player. As another example, a game in a dense urban area can add an area below ground by having a passageway, such as a secret door or new sinkhole, provide access to the new below ground area. In some games, players are allowed to select levels to play or naturally progress to the next level when finishing a level, in which case a game area that is a new level in the game can be added to the existing set of game areas and be accessible to a player. In some cases, a new game area does not correspond to a new location in the game, such as adding one or more new character, monster, decoration, collectable, object, puzzle, sub-plot, or story arc to existing locations in the game. For example, after adding a new game area new information may be available from existing NPCs in the game that can allow the player to solve a new puzzle to obtain a new item. A game without locations may have a game area added, such as adding a new set of cards to a trading card game. A new game area may provide the player with the ability to acquire one or more new things, such as decorative clothing, a magical weapon, a new game mechanic, new information, or access to a new skill. When creating new functional things, such as a magical weapon, a new game mechanic, or new skill, that can be obtained in a new game area care needs to be taken to ensure that it is created in a way that will preserve the game balance and not create something that is too powerful or underpowered to work well in the game, such as to balance it with the power of other items the player could obtain at their current advancement in the game. A new game area may provide the player with the ability to acquire one or more existing things, such as healing, food, weapons, crafting supplies, experience points, or contact with an existing NPC who has also traveled to the new game area.

According to embodiments, generative game world population may include determining at least one element for populating electronic game areas using a game world generation model. According to embodiments, a device may perform generative and/or training operations at block 120 for electronic game 100 using a game world generation model. According to embodiments, a game world generation model may be configured to generate, populate and configure one or more elements of electronic game 100. Configuring an element of an electronic game 100 may be based on a game element tag identifying the element for configuration. Alternatively or in combination, configuration of an element of an electronic game 100 may be based on a game area that may be generated by the game world generation model. Generation of a new area can include populating the area with one or more elements or constraints. According to embodiments, generative and/or training operations at block 120 may include one or more operations to identify elements of an electronic game, generate new areas and/or configure one or more game areas of electronic game 100. According to embodiments, generative and/or training operations at block 120 may be based on one or more detected user commands and/or interactions at block 125. Generative game world population may be based on one or more commands. By way of example, commands may be an input command for one or more of game engine command, game design command, game server command and game player command to populate at least one element of a game session. By way of example, a game engine command may be an instruction of electronic game 100 to generate a new game area or populate one or more existing areas of the game. During game design, a device may receive a game world input generation command by way of a user interface to generate a new game area or populate game areas. During game play, a game world generation input command may be received from users, such as players of the game, to generate a new game area. Similarly, one or more devices providing the electronic game, such as a server, may generate a game world generation input command to generate game areas and/or populate game areas.

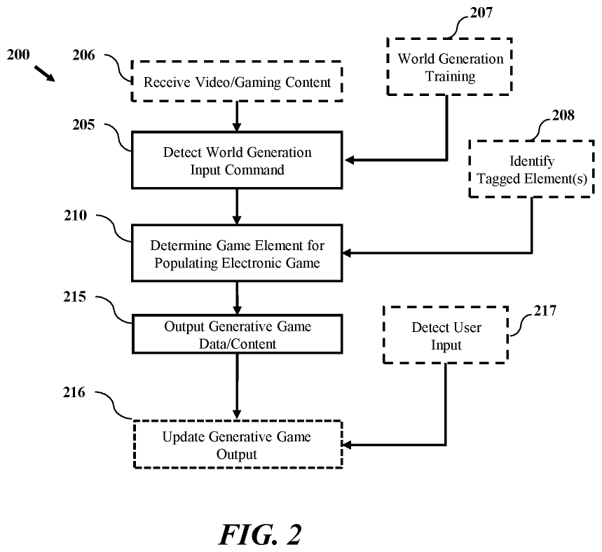

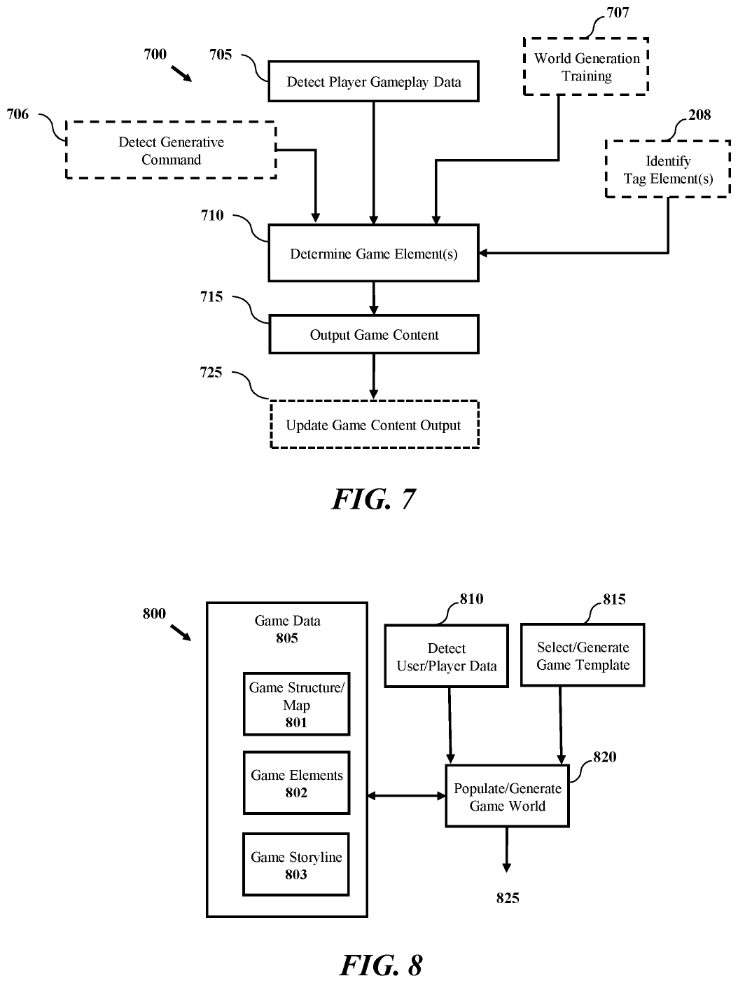

According to embodiments, electronic game 100 may be configured to provide features to improve user experience, wherein functions and operations described herein are performed following user consent, with express notice to a user, and/or in alignment with one or more user settings for user privacy. It should be appreciated that embodiments may be applied to interactive entertainment with one or more users. Processes described herein are not limited to gaming content. According to embodiments generative game world population may including performing one or more operations and processes discussed herein, such as process 200 of FIG. 2, and process 700 of FIG. 7.

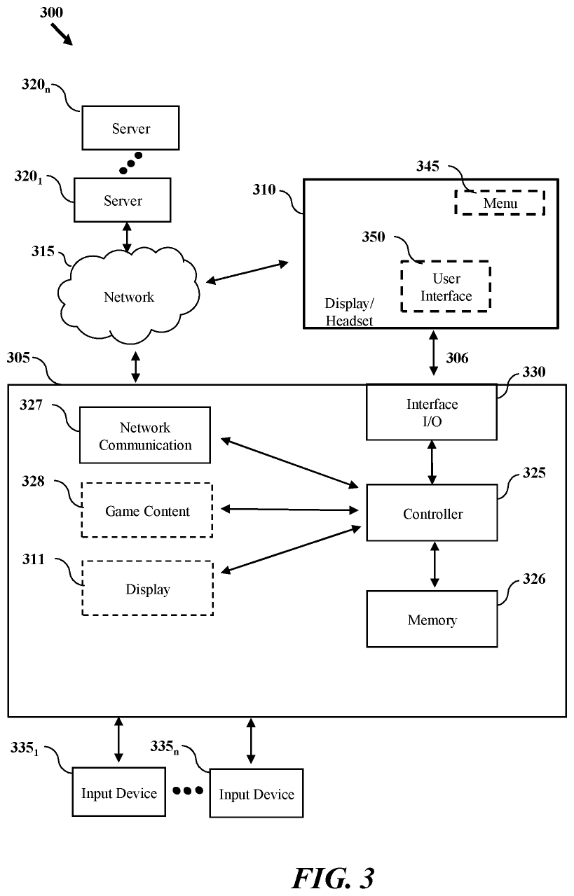

FIG. 2 illustrates a process for generative game world population according to one or more embodiments. Process 200 may be configured to generate one or more elements or configurations for electronic games, including a configuration of one or more existing elements of game elements and generating one or more new game elements and game areas. Process 200 may be performed by a device, such as device 305 and/or controller 325 of FIG. 3, for generative game world population.

Process 200 may be initiated by a device (e.g., device 305) detecting a game world generation input command for an electronic game at block 205. According to embodiments, a game world generation input command for an electronic game area may be detected by a device, such as one or more of a game console, network server and interactive entertainment device. A game world generation input command may be at least one of a game engine command, game design command, game server command and game player command to populate at least one element of a game session. Generative game world population can be performed at different stages of game development and/or for established games. During game development, a game input command can include generation of one or more of a game element for a game area and generation of a new game area. For established or existing electronic games, the generative game input command may be received during game play and/or in response to game play to generate one or more game elements for game areas. Similarly, the generation input command may be to initiate generation of a new game area or game storyline. The world generation input command may be detected based on game designer and developer input commands of a user interface for game design. For generated games, the world generation input command may be based on player controls of selections of a user interface and control panel for the electronic game.

Process 200 may be performed on electronic games (e.g., video games, interactive games, etc.). Electronic games may include one or more player controlled elements, a visual display or one or more levels or areas, and the ability of the user to control the character relative to one or more levels and areas. Electronic games may also include non-player elements such as non-player characters or playable game areas (e.g., routes), non-playable game areas, and various forms of displays. Games may include a storyline including character information such as a character backstory and one or more narrative components describing gameplay or the rationale for performing game tasks. These features may form or be part of a game standard. By way of example, a character storyline for a quest of a certain object may be a definitive feature and constraining factor when identifying generative features. Game standards may be described by data of the electronic game. Embodiments may include identifying and determining a game standard based on one or more of gameplay data and game engine data (e.g., game code).

According to embodiments, process 200 may optionally include receiving video and/or gaming content at block 206. Generative world population may be based on parameters of an electronic game. Electronic games may include characters, a theme and storyline. At optional block 206 one or more parameters may be received by way of video data and/or game data (e.g., game code, game engine data, game generation data, etc.). Received video and game a data at optional block 206 may be used to characterize a game and identify storyline and game components that complement or mesh with the features of the game.

According to embodiments, process 200 may optionally include performing world generation training at block 207. World generation training may be performed to generate and/or train a game world generation model. The world generation model may be used to generate elements, areas, themes, templates and/or game features to populate a new game world. World generation training at optional block 207 may be based on features of electronic games and training data in general for characters, storylines, themes and video generation. According to embodiments, world generation training at optional block 207 may including training a model to generate elements and areas for an electronic game using elements, areas and characteristics of an electronic game. By way of example, for a racing game, the model may be trained based on the racing vehicles and race tracks to generate a new race vehicle and/or a new race track. For an adventure game, the model may be trained based on a player controlled character, game antagonist (e.g., villain, boss, enemy, etc.), landscape, levels, tools, and of game parameters in general. World generation training may include identifying one or more game standards for an electronic game.

At block 210, process 200 includes determining at least one element for populating the electronic game area based on the world generation input command. According to embodiments, game element determination may be based a world generation input command. For a world generation input command during game design, determination of elements may be for populating an area, generating a new area, configuring an area, generating a storyline component and adding to a game storyline. For an already developed game, or existing game, a world generation input command may similarly may be for populating an area, generating a new area, configuring an area, generating a storyline component and adding to a game storyline. Processes and device configurations discussed herein may identify and/or generate a game world standard based data an electronic game. According to embodiments, generating elements, game areas and generative game world population for electronic games may be based on a game world standard for the electronic game. By using a game world standard, elements may be generated that allow for function and/or conformity to the electronic game. According to embodiments, a game world standard can define at least one parameter for generating at least one of a game level, game map, game storyline, design style for objects, and game elements. Game elements may include one or more of decorative objects, functional objects, side quests, sub-plots, history, NPCs, training, skills, treasure, achievement awards, puzzles, goals, contests, tournaments, socializations, combat challenges, and physical obstacles. Process 200 may identify and/or determine a game world standard based on received gaming content, world generation training and/or based on electronic game data. As an example, a game location may have one or more tags associated with the location, the one or more tags indicating aspects of a storyline that are to occur in that location. For example, a storyline may require a player to acquire a specific object. Depending on a last known location of the object and player past interactions with NPCs, a storyline can be generated for the game area that will accomplish the aspects from the game location tag and be consistent with the game play. The storyline generated from the game area can take into account player preferences or inferred interests to be more appealing to the player while still satisfying the constraints to fit into the game. In some cases, the storyline can lead to a different overall outcome or story direction depending on previous game play by the player. By way of example, player actions that angered or killed certain NPCs may result in a generated storyline not including partnership or rewards from the NPCs, however an opportunity for alliances may open up with others who oppose the NPCs.

According to embodiments, determining the at least one element for populating the electronic game area at block 210 includes generating at least one of content for a new game area of the electronic game and a new storyline component of the electronic game. According to embodiments, generative game world population and generative AI may be used in many ways for populating a game world, such as by game designers, by a game engine, by a game server, or by game players. When used by a game engine or game server, generative AI can replace traditional procedural generation of game content to result in creation of unique game content that does not suffer from being seen as repetitive by players. When used by game designers, generative AI can be used to generate many possibilities for populating a game area, such as a game level, city, country, island, planet, space ship, building interior, or dungeon. Designers can choose an interesting one to use as a basis for new content and can pick and choose elements from different generated content to use. When used by a player in a game, generative AI can allow the creation of new unique content by the player, instead of the traditional method of duplication of a fixed set of building elements. In an open world game with player created content, processes and operations described herein can provide for a very rich and constantly evolving environment for players to explore.

According to embodiments, generative AI can be used to generate content for populating new game areas, which may be newly created, or may already exist in the electronic game and need to be populated, such as a newly accessed planet or island. An area in a game can be seeded with a set of objects or descriptions to be used to guide generative AI in creating content for the area. By using generative AI to populate new game areas, a game can provide an endless unique game environment for a player to explore.

According to embodiments, generative AI can be used to create new non-player characters (NPCs) in a game and give each one their own look, personality, and background. NPCs may have information of interest to the player and can be used to reveal information to the player to advance the game story line. NPCs may have roles to play in a storyline, such as to enforce a theme by encouraging the player to take the right action or highlight a player's weakness or fear by tempting the player to give into a weakness or fear. A new NPC may be generated with a storyline role as the player acquires new goals, fears, weaknesses, or habits. An NPC may be generated in response to a tag associated with a game element, such as a goal, challenge, game area, NPC, or point in the storyline, where the tag indicates storyline aspects that should be fulfilled by an NPC.

According to embodiments, determining the at least one element for populating an electronic game area includes generating at least one game element and a game area based on a storyline of the electronic game and a design theme of the electronic game. An area in a game world being populated can have a consistent design, theme, or logic that is specific to that area. An area in a game world can have sub-areas within it, in which case the standards for the area can be applied to the sub-area as well as sub-area standards. In some cases, standards for a sub-area may override standards for the larger area in which it is embedded. The game title can act as an area and have standards that are applied to it and the areas embedded within it. Generative AI population can fill in an area in a game world with new content that is conformant with the standards of the area, including any standards inherited from an area the area is embedded within. Generative AI can be used to add areas to a game that each have a unique feel to the players.

According to embodiments, determining the at least one element for populating the electronic game area includes generating at least one game object and at least one display characteristic to populate the electronic game area, and wherein determining the at least one element includes generating elements for a template of the game area. Process 200 may be configured to characterize a game area and elements determined may be based on a theme or style to apply to in game elements. By way of example, a first music or audio accompaniment may be selected for a game area that includes a in room, and a second music or audio accompaniment may be selected for an outdoor or nature theme of a game area. As another example, a game location may have particular musical aspects associated with it, such as through tags associated with the game location indicating the associated musical aspects to apply when the player is in the location, and an NPC may have particular musical aspects associated with it. When the player encounters the NPC in the game location a new musical composition can be generated and played that takes into account the musical aspects associated with the game location and the musical aspects associated with the NPC. Musical aspects can include things such as themes, melodies, lyrics, genres, instrumentation, keys, tempo, emotional impact, and style. Game area elements, storyline elements and characters may be used to generate the appearance of a room, elements in the room and the room appearance style. Elements may be generated based on age appropriateness of players, such that a room or a bar may be modified to a café or restaurant based on player age level.

According to embodiments, generative AI can be used to fill in an empty framework or template for a new game area. This can be used to ensure that what is generated is functional and consistent with other areas in the game title. According to embodiments, determining the at least one element for populating the electronic game area includes generating display elements for the at least one element in a newly generated game area, wherein the device uses a template generated for the electronic game to determine display attributes and game function of the at least one element. An electronic game may include use of a template for populating game areas, such as first template for a first game area or level, and a second template for a second game area of level.

According to embodiments, a combination of procedural generation and artificial intelligence can be used for generative game world population. For example, procedural generation may be used to generate a new empty game level with standard features for the game, such as a difficulty level, defined entry point, and defined exit point which can ensure that the generated content fits well within the game. Operations for generative game world population can then populate the content within the new procedurally generated level. Operations for generative game world population can be given a set of constraints to satisfy when generating content, which may include constraints on the quantity, locations, types, or power level for things such as treasure, healing, traps, or monsters. In some cases, operations for generative game world population may fill in an area that has predefined boarders that it must be consistent with, such as the left edge bordering on a forest with a road in the middle of the edge and the right edge bordering a grassy plain at the top and an ocean at the bottom. In some cases, the area to fill may have constraints that extend into the area, such as to populate an unexplored area of a map that shows a road and a river crossing through the area. In another example, operations for generative game world population can determine the layout and contents of a generated area while procedural methods are used to fill in the details of objects determined by generative game world population, such as to procedurally add details to a travel portal placed by generative game world population so it looks and functions similarly to other travel portals in the game and is linked to be able to allow travel to other travel portals in the game

According to embodiments, wherein determining the at least one element for populating the electronic game area includes generating a new game area for the electronic game using a game world generation model trained to generate the new game area based on a game area standard to include new game content. By way of example, world generation training at optional block 207 may generate and/or train a model which may be used to identify and/or populate game elements.

At block 208, process 200 may optionally including identifying at least one tagged element. According to embodiments, electronic games may include one or more element tags or tagged elements in electronic game data. A tagged element may be a game element that may be populated by a device. The tagged element may be a placeholder for including or configuring an element. By way of example, an electronic game may include a background with a first display configuration. The background may be tagged, such that generative game world population include configuring the background. Similarly for player controlled elements, a player character may be tagged. Alternatively or in combination, other game elements a non-player characters may be tagged to allow for configuration. According to embodiment, a game world generation input command may be detected based on detection of a game element tag in the electronic game area, the game element tag including a description of a game element for configuration. Process 210 can determine one or more tags to include in generated content to guide generation of content that is contained in, or otherwise associated with, the generated content, which can be included in the generated content by process 215. Such hierarchical use of tags in generated content can lead to greater consistency among related content generated.

At block 215, process 200 includes outputting generative game data and/or content. Outputting game data can include game data generated for an electronic game area. The generated game data may be output with the game data. For example, a background generated for the game may be inserted in pace of an existing background. Alternatively a formatted object may be output with the generated formatting at least one element. Outputting game data for the electronic game includes display of the at least one element during a game session.

Process 200 may optionally include updated generative game output at block 216. Process 200 may be configured to update generative content based on game world standards and game content of the electronic game. According to embodiments, generative game world population may be based on the electronic game content output. Accordingly, advancing to a different game area or level may initiate updating of generative game content. Process 200 may optionally include detecting user input at block 217. According to embodiments and discussed in more detail herein, generative world population may be based on user input controls and actions. User input detected at optional block 217 may be used to updated generative game output at optional block 216. Process 700 of FIG. 7 describes operations for generative game world population and player customization according to one or more embodiments.

FIG. 3 illustrates a graphical representation of a system and device for identifying game world generation according to one or more embodiments. According to embodiments, game world generation may be performed and used by a device or a system, such as a network gaming system. A system can include one or more components and devices. FIG. 3 illustrates system 300 according to embodiments which can include device 305. Device 305 may be one or more of a gaming console, computing device and electronic device in general configured to output gaming content 306 to display 310 and may include output of generated game worlds and electronic game content. With respect to gaming content, device 305 may be configured to output data for presentation by a display, or visual output device in general, including graphics (2D and 3D), sound and data. Device 305 may also be configured to output non-gaming content, such as video content, visual content, audio content, etc. Embodiments describe generating generative game world population for electronic games and gaming, however it should be appreciated that the principles of the disclosure may be applied to other forms of media and non-gaming content. As such, device 305 and system 300 may be configured for generative operations that may be applied for one or more applications.

According to embodiments, device 305 is configured to output data 306 and/or content to display 310. According to embodiments, display 310 may be separate from or part of device 305. Device 305 may be configured for network communication by way of network 315 with one or more servers 3201-n. Network communication can include one or more network communication type (e.g., Local Area Network (LAN), Metropolitan Area Network (MAN), Wide Area Network (WAN), Wireless, Inter Network (Internet). Device 305 may be configured to receive one or more of user data, game data and video data from servers 3201-n. Servers 3201-n may be configured to store one or more of user data, game data and generative data.

FIG. 3 depicts a device configuration according to embodiments. Device 305 may relate to a console, media device, and/or handheld device. Device 305 may be configured to generate game data including configuring and populating existing game areas of a game, and generating new game areas for a game. Device 305 may be configured to perform one or more processes described herein for generative game world population. According to embodiments, device 305 includes controller 325, and memory 326. Device 305 may also include network communication module 327. Device 305 may also optionally include game content 328. Device 305 may optionally include a display 311 and/or may interoperate with display 310.

Controller 325 may relate to a processor or control device configured to execute one or more operations (e.g., executable instructions) stored in memory 326, such as processes for game world generation and game world population. Controller 305 may be coupled to memory 326, network communication module 327, and interface (I/O) 330. Memory 326 may be non-transitory memory configured to provide data storage and working memory operations for device 305. Memory 326 may be configured to store computer readable instructions for execution by controller 325 for one or more processes described herein. Network communication module 327 may be a communications module configured to receive and transmit network communication data.

According to embodiments, device 305 may be configured for generative game world population. According to embodiments, device 305 may be configured to detect a game world generation input command for an electronic game area. Device 305 may be configured to determine at least one element for populating the electronic game area based on the world generation input command, wherein the determining the at least one element is based on a game world standard. Device 305 may be configured to output game data for the electronic game area with the at least one element object.

According to embodiments, device 305 may be configured for generative game world population and player customization. Device 305 may be configured to detect player data for at least one player of an electronic game, wherein detecting player data includes detecting in-game player interactions with elements of the electronic game. Device 305 may be configured to determine at least one element for populating a game area of the electronic game based on the player data for at least one player, wherein the determining the at least one element is based on the in-game player interactions. Device 305 may be configured to output game data with the at least one element for populating the game area.

Device 305 may be configured to receive gaming media (e.g., card, cartridge, disk, code, data, etc.) and output visual and audio content of the gaming media to display 310. Device 305 may be configured to receive data from one or more of servers 320₁₋ₙ to present and output game content 328, which may be stored in memory 326. For network games, device 305 may receive game data from a network source, such as servers 320₁₋ₙ, and may be configured to generate gaming music for the game data. Device 305 may similarly be configured to receive video content in general, including non-network game data, and output video content.

Device 305 may be configured to receive input from one or more peripheral devices, such as input devices 335₁₋ₙ. Input devices 335₁₋ₙ may be controllers or input devices in general configured to provide controls for device 305 and game control.

System 300 may include display 310 for output of visual and audio of an electronic game and/or output of device 305. According to embodiments, display 310 may display control elements of device 305, such as optional menu 350, which may be used to interface with device 305. Display 310 may output user interface 350 received from device 305. Device 300 may utilize one or more operations of processes described herein. It should also be appreciated that system 300 and its components may be configured to perform operations of device 305.

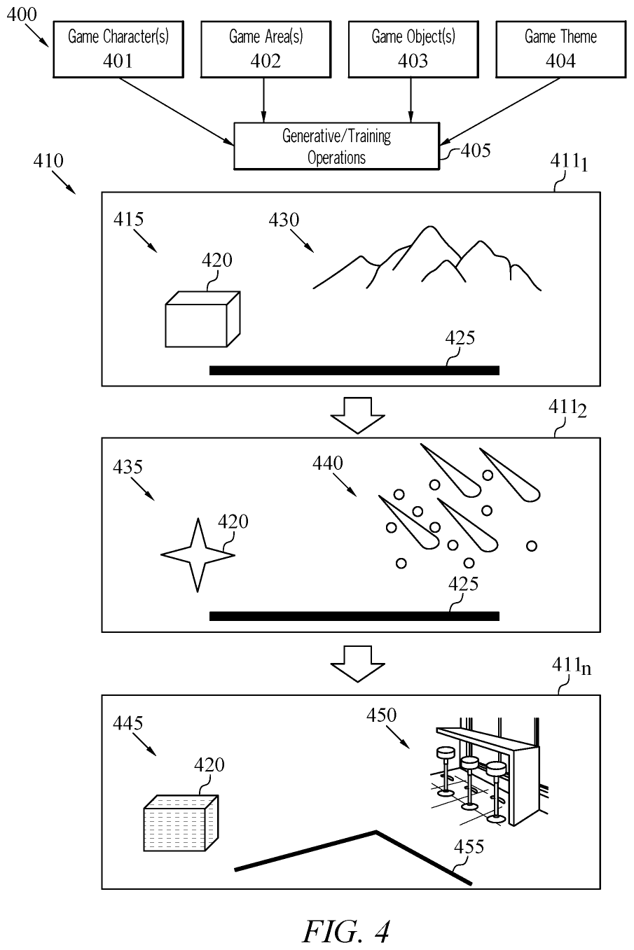

FIG. 4 illustrates a graphical representation of game world generation according to one or more embodiments. According to embodiments, process 400 for generative game world population includes performing world generation training for a model and determining at least one element for populating the electronic game area using the model. In contrast to running a preprogrammed series of events or stages, embodiments provide operations and device configurations to generate one or more game elements, such as a game area, game object, game theme, etc. for an electronic game using at least one model. Training models may be configured to identify parameters from input, such as features of an electronic game, and generate one or more of configurations for the electronic game including configurations that are not preprogrammed. Game world population may include configuring preprogrammed elements, such as applying themes, however, it should be appreciated that generative game world population may include generation of new elements and/or areas in addition to and/or separate from preprogrammed electronic game data.

According to embodiments, process 400 can include receiving game content including one or more of data for game character(s) 401, data for game area(s) 402, data for game object(s) 403 and data for one or more game themes 404. Based on received game content process 400 may perform one or more generative and/or training operations 405. According to embodiments, training operations may be performed to train a generative game model to generate one or more of a character, game area, game object and game theme. Training operations at 405 may include identifying one or more game standards using one or more of game character(s) 401, data for game area(s) 402, data for game object(s) 403 and data for one or more game themes 404. Game standards may include one or more functional limitations. For example, a game standard may limit the control movements of a game object. Game standards may have design themes or display characteristics. For example, a game standard may limit the amount of background elements for a game area. Generative operations may include generating one or more of a character, game area, game object and game theme.

Generative and/or training operations 405 can include generating and/or training a game world generation model. The world generation model may be used to generate elements, areas, themes, templates and/or game features to populate a new game world. The world generation model may detect tags associated with inputs provided to it, which may be used to determine constraints that the world generation fulfils. World generation training at block 405 may be based on features of electronic games and training data in general for characters, storylines, themes and video generation. According to embodiments, world generation training at block 405 may including training a model to generate elements and areas for an electronic game using elements, areas and characteristics of an electronic game. By way of example, for a racing game, the model may be trained based on the racing vehicles and race tracks to generate a new race vehicle and/or a new race track. For an adventure game, the model may be trained based on a player controlled character, game antagonist (e.g., villain, boss, enemy, etc.), landscape, levels, tools, and of game parameters in general. World generation training may include identifying one or more game standards for an electronic game.

According to embodiments, process 400 can include outputting game data 410 for the electronic game area with the at least one generated element. Outputting game data at 410 can include a plurality of game areas 411₁₋ₙ. According to embodiments, game area 411₁ may be output including background 415, configurable game object 420, game object 425 and theme element 430. According to embodiments, game area 411₁ may relate to a game area of an electronic game and generative world population may be configured to modify and/or generate one or more game elements for game area 411₁. Background 415 may include one or more ornamental and functional elements that may be modified. Configurable game object 420 may relate to a tagged element such that a device may be configured to modify one or more of the function and appearance of an object that is tagged. Game object 425 may be a game feature such as a barrier, path or landing feature. The arrangement of elements in game area 411₁ may be adjusted based on operations for generative game world population.

According to embodiments, generative game world population may include populating a game area and/or generating a new game element. Outputting game data 410 includes outputting at least one element in game area 411₂. Game area 411₂ may be generated to include background 430, configurable game object 420, game object 425 and theme element 440. According to embodiments, game area 411₂ may relate to modified or updated version of game area 411₁. By way of example, game area 411₂ may be modified to update at least one appearance and function of one or more game elements. Game area 411₂ may include one or more updated elements of background 435 including theme elements 440 modified from game area 411₁. Configurable game object 420 may be updated to appear as having a modified graphical representation (e.g., a star representation for illustration of an appearance change) in game area 411₂. Game object 425 may be presented as a game feature. According to embodiments, game area 411₂ may relate to a graphical representation of a modified game area of an electronic game. According to other embodiments, game area 411₂ may relate to a new area of an electronic game.

According to embodiments, process 400 can include outputting game data 410 for the electronic game area with the at least one generated element based on a game area template. According to embodiments, a game area template may identify one or more features or elements for populating a game world. According to embodiments, generative game world population may include populating a game area and/or generating a new game element for a plurality of game areas with a game area template. Outputting game data 410 includes outputting at least one element in game area 411ₙ. Game area 411ₙ may be generated to include background 445, configurable game object 420, game object 455 and theme element 450. According to embodiments, game area 411ₙ may relate to modified or updated version of game area 411₁. By way of example, game area 411ₙ may be modified to update at least one appearance and function of one or more game elements. According to embodiments, game area 411ₙ may relate to game area generated based on a template generated from game area 411₁. Game area 411ₙ may include one or more updated elements of background 445 including theme elements 450 modified from game area 411₁. Configurable game object 420 may be updated to appear as having a modified graphical representation (e.g., display treatment) in game area 411ₙ. Game object 455 may be presented as a game feature having a modified appearance and function (e.g., change in shape defining change in controllable area). According to embodiments, game area 411ₙ may relate to a graphical representation of a modified game area of an electronic game. According to other embodiments, game area 411ₙ may relate to a new area of an electronic game.

According to embodiments, game areas 411₁₋ₙ may relate to one or more game areas generated for an open world of an electronic game. Game areas 411₁₋ₙ may be generated based on closed loop adaptive story learning and detection of electronic game elements. According to embodiments, elements of an electronic game may be detected and used as a reference for generative elements. Elements may be detected based on a player preference or interaction and used to custom fit game areas to one or more users. User preferences may be detected based on voice input or commands, such as speaking to a game console with an instruction to paint the background a color or convert a background to be a country themed saloon, a neon bar or city cafe. Unlike convention games with preprogrammed content, process 400 and processes described herein may generate game areas in user to user commands and requests. Generation of elements may interact with a game engine to allow for presentation on content and allow for gameplay.

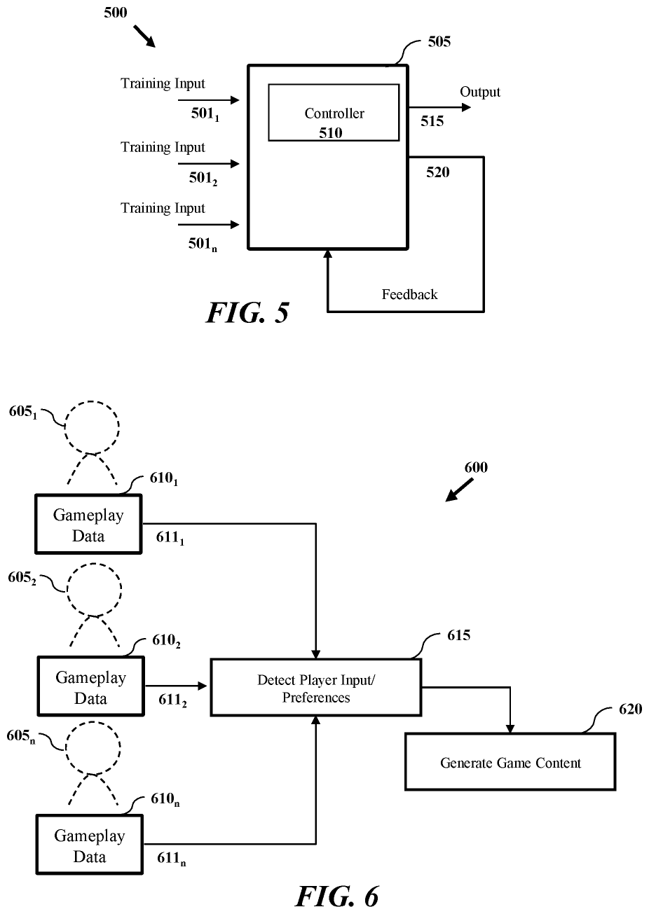

FIG. 5 illustrates a graphical representation of game world training according to one or more embodiments. According to embodiments, game world determinations may be performed using one or more references and models. Contextual information for objects, object function and object appearance may be determined based on a training process. FIG. 5 illustrates training process 500 which can include receiving training input 501₁₋ₙ by a device 505 including a controller 510. According to embodiments, controller 510 may receive a plurality of gameplay videos and/or electronic game data for an electronic game as training input 501₁₋ₙ. In embodiments, training input 501₁₋ₙ may relate to rendered video data for a particular electronic game and one or more additional electronic games. Training input 501₁₋ₙ can include one or more references for storyline parameters. Training input 501₁₋ₙ may include game engine data for one or more electronic games. Based on the training in process 500, controller 510 may generate output 515. Output 515 may include one or more determined objects, game areas, game storylines, electronic game modifications, new characters, character speech and elements for populating game worlds. According to embodiments, controller 510 may be configured to generate output 515 based on a recursive loop including training and feedback. Feedback loop 520 may provide information such as ratings and accuracy for output 515.

According to embodiments, training process 500 and controller 510 may be configured to use one or more learning models (e.g., artificial intelligence, iterative models, etc.) to recognize objects and elements in an electronic game. Training process 500 and controller 510 may use one or more libraries of common electronic game objects, including object images and object descriptions.

FIG. 6 illustrates a graphical representation of customizing game world generation for players according to one or more embodiments. According embodiments, devices and processes are provided for generative game world population and player customization. Process 600 includes a plurality of gameplay data sources 6101-n associated with players 6051-n of an electronic game. Gameplay data sources 6101-n may relate to gameplay devices, such as game consoles, personal devices and computers configured to output player controls 6111-n. Process 600 may include detecting in-game player interactions, such as player input controls and preferences at block 615. According to embodiments, game content may be generated at block 620 using detected player input and/or preferences at block 620. According to embodiments, processes and operations described herein may be performed by one or more control devices. Alternatively or in combination, processes and operations described herein may be performed by one or more servers.

FIG. 7 illustrates a process for generative game world population and player customization according to one or more embodiments. Process 700 maybe initiated with detecting player gameplay data at block 705. Player gameplay data detected at block 705 may include user input controls, user commands (e.g., voice, user interface, etc.), user reactions and user preferences for one or more electronic games. Player data may be detected for at least one player of an electronic game. According to embodiments, detecting player data includes detecting in-game player interactions with elements of the electronic game. Detecting player data can include detecting input controls for a multiplayer game and identifying an in-game preference for the at least one player of the electronic game.

Process 700 may optionally include detecting a generative input command at block 706. Similarly, process 700 may include performing world generation training at block 707 and identification of tagged elements at block 208. Operations for detecting generative commands, world generation training and identification of tag elements may be similar to operations discussed above with reference to process 200 of FIG. 2.

At block 710, process 700 includes determining, by the device, at least one element for populating a game area of the electronic game based on the player data for at least one player. Elements for populating a game world may be determined based on the in-game player interactions. According to embodiments, determining the at least one element includes detecting player data for a first player and player data for a second player, identifying a preference based on the player data for the first player and the player data for the second player, and generating the at least one element in a game area of the electronic game based on a game world standard.

Process 700 can learn from player preferences and/or observations of player gameplay to identify game elements that are engaging or enjoyable for the player. This information can be used by the generative population operations to create game content that is customized for the player based on what the player finds engaging or enjoyable about game play and/or a game title. Generative population operations can create a new game area populated by content customized to the player. Generative population operations can populate a new game area for a player based on elements of other game areas that the player liked. Generative population operations may detect player mood and generate content for the player based on the detected mood.

Process 700 may include generative population operations for determining elements of an electronic game. According to embodiments, determining the at least one element includes selecting a template for populating the game area using the in-game player interactions, and populating at least one tag element of the template. Determining the at least one element includes setting at least one style for the at least one element using the player data for at least one player. According to embodiments, generative population operations may generate content specifically for the players in a multi-player game environment, then content generated specifically for each player may be used in that game environment. In some cases, a player may interact with content that was generated specifically for another player. According to embodiments, when multiple players play in the same multi-player game environment together, generative population operations can generate music for the game environment that takes the musical preferences of all players into account. Generative population operations for music and audio output may take into account game state, such as the mood or emotions that the current game state is attempting to create in the player and what game elements are present. Different musical motifs or themes can be used for different game elements or areas, as well as one or more motifs or themes for the overall game music. These musical motifs and themes can be styled based on the preferences of players. According to embodiments, content created by generative population operations can be used across multiple game titles. According to embodiments, an overall musical style may be used across a whole game title, such as an orchestral soundtrack. The overall musical style may then be applied to new music created by generative population operations for use in the game, such as in a newly generated game area. Created content can be generated by a game server or can be created locally on the device where a game is played. In addition, content that is created locally can be uploaded to a server for sharing.

According to embodiments, determining the at least one element includes generating an adaptive storyline for the electronic game based on the in-game player interactions. According to embodiments, determining the at least one element includes generating a new storyline for the electronic game based on the in-game player interactions, and inserting the new storyline into the electronic game. According to embodiments, determining the at least one element includes generating at least one of audio output and music output for the electronic game based on the in-game player interactions. According to embodiments, determining the at least one element includes generating a new game area for the electronic game using a game world generation model trained to generate the new game area based on the in-game player interactions to include new game content.

Process 700 includes outputting game data at block 715 with the at least one element for populating the game area. Process 700 may optionally include updating game content at block 725. Outputting game data for the electronic game includes output of the at least one element during a game session to a first player and a second player of the electronic game.

FIG. 8 illustrates a graphical representation of generating game world content for players according to one or more embodiments. According to embodiments, generative game world population and player customization may be based on parameters of an electronic game to provide consistency with generative content and electronic game content. Generative content may be based on one or more game templates. Process 800 may be configured for populating a one or more game areas based on player customization using game data 805 for electronic game. Electronic game data 805 for an may include game structure/map data 801, game element data 802 and game storyline data 803 for an electronic game. Game structure/map data 801 may include a description of game layout, format of levels or game areas, and relationship of game areas relative to a game storyline. Game element data 802 may include a description of game objects, game object function, use of game objects in a game area. Game storyline data 803 may include a description of one or more game storylines for characters of a game.

Process 800 may be configured to generate one or more game areas using electronic game data, player interaction data and one or more game templates. Process 800 may include receiving game data 805, detecting user/player data at block 810 and selecting/generating a game template at block 815. At block 820, process 800 includes populating and/or generating at least one game world area. Generated game world data 825 may be output for presentation to one or more players.

According to embodiments, generative AI can learn at a game title level what content is liked by players across all player interactions with generated content. Some players may respond differently to content than others. AI can detect the different ways that players react to content and group players based on how they react to content, which can allow generative AI to create content specifically for a group of players with similar preferences.

According to embodiments, generative AI can be used to group content so that content liked by the same player is grouped together. If a group of players has similar preferences, then content can be grouped based on the reactions of players in that group to the content. This can allow different game areas to be populated by content from different groups, which can result in consistency within game areas as well as differentiation between game areas.

According to embodiments, generative AI can be used to create an adaptive story line based on player actions in game. As such, player actions can be used to control an electronic game and game story. With traditional game story lines that are linear. According to embodiments, as a player effects a game story, the story elements that have not been revealed to the player can be modified to fit in with the new changes introduced by the player in a way that will still weave together at the end of the story. Meeting an NPC later in the game can result in the NPC referring to an action that the player took earlier, which will give the player the feeling that they are living in the game environment and effecting it rather than just observing a predetermined story.

According to embodiments, generative AI can be used to create a collection of game content and have similar content grouped together to create or populate areas with them to give those areas a sense of consistency. Similarities can be determined by AI analysis of game content or by AI analysis of player reactions to or interactions with game content.

According to embodiments, generative AI can be used to create content that is used for a whole game title, a game area shared by multiple players, game play by a single player, or within a single game play instance. In some cases, created content may start out with a narrow scope of availability, such as specific to a particular player, and then be made available more widely, such as in a particular shared game world, based on player reactions to the content that are deemed favorable. In some cases, content created for first player can be made available to a second player if the first player's reaction to the content is favorable. In some cases, if a certain number of individual players react favorably to created content, then the created content can be shared more widely, such as to populate in a game world accessible by any player.

While this disclosure has been particularly shown and described with references to exemplary embodiments thereof, it will be understood by those skilled in the art that various changes in form and details may be made therein without departing from the scope of the claimed embodiments.

What is claimed is:

1. A method for generative game world population, the method comprising:
detecting, by a device, a game world generation input command for an electronic game area;
determining, by the device, at least one element for populating the electronic game area based on the world generation input command, wherein the determining the at least one element is based on a game world standard; and
outputting, by the device, game data for the electronic game area with the at least one element.

2. The method of claim 1, wherein the game world generation input command is at least one of a game engine command, game design command, game server command and game player command to populate at least one element of a game session.

3. The method of claim 1, wherein the game world standard defines at least one parameter for generating at least one of a game level, game map, game storyline, design style for objects, and game elements.

4. The method of claim 1, wherein the game world generation input command includes detection of a game element tag in the electronic game area, the game element tag including a description of a game element for configuration.

5. The method of claim 1, wherein determining the at least one element for populating the electronic game area includes generating at least one of content for a new game area of the electronic game and a new storyline component of the electronic game.

6. The method of claim 1, wherein determining the at least one element for populating the electronic game area includes generating at least one game element and a game area based on a storyline of the electronic game and a design theme of the electronic game.

7. The method of claim 1, wherein determining the at least one element for populating the electronic game area includes generating at least one game object and at least one display characteristic to populate the electronic game area, and wherein determining the at least one element includes generating elements for a template of the game area.

8. The method of claim 1, wherein determining the at least one element for populating the electronic game area includes generating a new game area for the electronic game using a game world generation model trained to generate the new game area based on a game area standard to include new game content.

9. The method of claim 1, wherein determining the at least one element for populating the electronic game area includes generating display elements for the at least one element in a newly generated game area, wherein the device uses a template generated for the electronic game to determine display attributes and game function of the at least one element.

10. The method of claim 1, wherein outputting game data for the electronic game includes display of the at least one element during a game session.

11. A device configured for generative game world population, the device comprising:
an interface;
a memory storing executable instructions; and
a controller coupled to the interface and the memory, wherein the controller is configured to
detect a game world generation input command for an electronic game area;
determine at least one element for populating the electronic game area based on the world generation input command, wherein the determining the at least one element is based on a game world standard; and
output game data for the electronic game area with the at least one element object.

12. The device of claim 11, wherein the game world generation input command is at least one of a game engine command, game design command, game server command and game player command to populate at least one element of a game session.

13. The device of claim 11, wherein the game world standard defines at least one parameter for generating at least one of a game level, game map, game storyline, design style for objects, and game elements.

14. The device of claim 11, wherein the game world generation input command includes detection of a game element tag in the electronic game area, the game element tag including a description of a game element for configuration.

15. The device of claim 11, wherein determining the at least one element for populating the electronic game area includes generating at least one of content for a new game area of the electronic game and a new storyline component of the electronic game.

16. The device of claim 11, wherein determining the at least one element for populating the electronic game area includes generating at least one game element and a game area based on a storyline of the electronic game and a design theme of the electronic game.

17. The device of claim 11, wherein determining the at least one element for populating the electronic game area includes generating at least one game object and at least one display characteristic to populate the electronic game area, and wherein determining the at least one element includes generating elements for a template of the game area.

18. The device of claim 11, wherein determining the at least one element for populating the electronic game area includes generating a new game area for the electronic game using a game world generation model trained to generate the new game area based on a game area standard to include new game content.

19. The device of claim 11, wherein determining the at least one element for populating the electronic game area includes generating display elements for the at least one element in a newly generated game area, wherein the device uses a template generated for the electronic game to determine display attributes and game function of the at least one element.

20. The device of claim 11, wherein outputting game data for the electronic game includes display of the at least one element during a game session.
